(19) United States
(12) Patent Application Publication
(10) Pub. No.: US 2025/0055871 A1
(43) Pub. Date: Feb. 13, 2025

(54) Methods Circuits Devices Systems and Functionally Associated Machine Executable Code for Context-Aware Zero Trust Monitoring of Critical Infrastructure Data Network Messages

(71) Applicant: CERVELLO LTD, Tel-Aviv (IL)

(72) Inventor: Shaked Kafzan, Tel-Aviv (IL)

(73) Assignee: CERVELLO LTD, Tel-Aviv (IL)

(21) Appl. No.: 18/446,499

(22) Filed: Aug. 9, 2023

Related U.S. Application Data
(60) Provisional application No. 63/366,148, filed on Jun. 10, 2022.

(51) Int. Cl. H04L 9/40

(52) U.S. Cl. CPC H04L 63/1433; H04L 63/1416

(57) ABSTRACT

Disclosed are methods, circuits, devices, systems and functionally associated machine executable code for context aware zero trust monitoring of critical infrastructure data network messages. Monitoring agents are functionally associated with and monitoring message communications to and from each of one or more transportation network units regulating components of the transportation network. Transportation network message evaluation logics evaluate a message intercepted by one of the monitoring agents, wherein each evaluation logic detects adherence violations of the message from a different transportation network aspect protocol. a scoring module for calculating, for each of the transportation network evaluated aspects, a score, a score aggregation module aggregates the message's scores, and a thresholding module compares the aggregated message score to a message adherence violation score threshold.

### FIELD OF THE INVENTION

The present invention generally relates to the fields of cybersecurity of critical infrastructure and transportation networks, such as railway fleets' operational network security. More specifically, the present invention relates to methods, circuits, devices, systems and functionally associated machine executable code for context aware zero trust monitoring of critical infrastructure data network messages.

### BACKGROUND

The term “zero trust” was coined in April 1994 by Stephen Paul Marsh in his doctoral thesis on computer security at the University of Stirling. Marsh's work studied trust as something finite that can be described mathematically, asserting that the concept of trust transcends human factors such as morality, ethics, lawfulness, justice, and judgement.

The challenges of defining the perimeter to an organization's IT systems was highlighted by the Jericho Forum in 2003, discussing the trend of what was then coined “de-parameterization”. In 2009, Google implemented a zero trust architecture referred to as BeyondCorp. The term zero trust model was used in 2010 by analyst John Kindervag of Forrester Research to denote stricter cybersecurity programs and access control within corporations. However, it would take almost a decade for zero trust architectures to become prevalent, driven in part by increased adoption of mobile and cloud services.

In 2019 the United Kingdom National Cyber Security Centre (NCSC) recommended that network architects consider a zero trust approach for new IT deployments, particularly where significant use of cloud services is planned.

In 2018, work undertaken in the United States by cybersecurity researchers at NIST and NCCoE led to the publication of SP 800-207, Zero Trust Architecture. The publication defines zero trust (ZT) as a collection of concepts and ideas designed to reduce the uncertainty in enforcing accurate, per-request access decisions in information systems and services in the face of a network viewed as compromised. A zero trust architecture (ZTA) is an enterprise's cyber security plan that utilizes zero trust concepts and encompasses component relationships, workflow planning, and access policies. Therefore, a zero trust enterprise is the network infrastructure (physical and virtual) and operational policies that are in place for an enterprise as a product of a zero trust architecture plan.

There remains a need, in the fields of cybersecurity of critical infrastructure and transportation networks such as railway fleet networks, for context aware zero trust cybersecurity solutions that evaluate data network messages based on operational aspects and statuses of the infrastructure being protected.

### SUMMARY OF THE INVENTION

Embodiments of the present invention may include methods, circuits, devices, systems and functionally associated machine executable code for context aware zero trust monitoring of messages traversing a data communication network integral or otherwise functionally associated with critical infrastructure, such as for example a transportation network. According to some embodiments, the monitored messages, encapsulated in data packets traversing the network, are intercepted at a node of the network by a message monitoring agent, which message monitoring agent may be implemented in dedicated hardware, in firmware, in software or by some combination of the three.

Intercepted messages may be inspected according to a context aware zero trust policy or methodology which intercepts and inspects substantially all messages traversing the data communication network, or substantially all messages to critical infrastructure assets such as transportation network management units, for network rule violations. The context aware zero trust policy or methodology may, in accordance with embodiments, regard by default any intercepted message as a potential cybersecurity threat, until the message is inspected and validated/cleared by the policy. Substantially all intercepted messages may be regarded as a potential cybersecurity threat, and inspected, regardless of their source and/or destination.

A context aware zero trust policy or methodology may, in accordance with embodiments, inspect and evaluate intercepted messages based on different aspects associated with the critical infrastructure being secured and/or its current context or state. A given message may accordingly be evaluated, and rated/scored, under each of the different aspects. The given message's scores for each of the evaluated aspects may then be aggregated to generate an overall score of the message that may be compared to a threshold value. An overall score greater than the threshold value may indicate that the given message could not be cleared and is to be regarded as a potential cybersecurity threat, whereas an overall score lesser than the threshold value may indicate that the given message has been cleared and is to be regarded as including no cybersecurity threat. Messages regarded as a potential cybersecurity threat may be notified, alerted, flagged, re-inspected and/or blocked; messages regarded as including no cybersecurity threat may be allowed to continue to their critical infrastructure (e.g. transportation network management) destination units/assets and trigger their intended action or operation.

According to some embodiments, messages traversing a data communication network integral or otherwise functionally associated with a transportation network, may for example be inspected and evaluated based on, or within the context or state of, the following aspects of the transportation network: (1) Geolocation of Communicating Transportation Network Units; (2) Operational Behavior of Communicating Transportation Network Units; (3) Potential Safety Rule Breach by Transportation Network Units Communications; and/or (4) Transportation Protocol Adherence of Communicating Transportation Network Units.

According to some embodiments, inspecting a transportation network message may include its evaluation based on, or within the context or state of, any combination of the described aspects. For a given inspected message, one or more violations/anomalies may each be scored and recorded under each of the examined aspects; combining the given inspected message's scores within a specific aspect—for example, by adding, averaging, calculating a values distribution measure, and/or calculating a central tendency measure, of the scores—may constitute the given message's score for the specific aspect. A given message's scores in two or more different message scoring aspects may be aggregated or combined—for example, by adding, averaging, calculating a values distribution measure, and/or calculating a central tendency measure, of the scores—to generate an overall cybersecurity threat level score, for that given message.

According to some embodiments, the calculated overall cybersecurity threat level of a given transportation network message may be compared to a threshold value. A message having a low overall cybersecurity threat level, at or below the set threshold, may be regarded as ‘validated’ or ‘cleared’ and thus Ignored, relayed-to-destination, allowed-to-continue, labeled as safe and/or notified as such. A message having a high overall cybersecurity threat level, at or above the set threshold, may be regarded as ‘not cleared’ and thus blocked, buffered, reevaluated, labeled as a potential threat and/or notified as such.

According to some embodiments, a critical infrastructure future state simulation engine may predict a future state or context of the infrastructure's operational units/assets. For example, a railway transportation network infrastructure future state simulation engine may predict the locations/positions, and/or the operational states/orientations, of at least some of the railway transportation network's units/assets, or of units/assets within a specific relevant node of the network.

According to some embodiments, intercepted messages may be inspected according to a context aware zero trust policy or methodology which factors a sensitivity level of the transportation network to the inspected message in setting an anomaly/violation tolerance threshold for the message.

Message sensitivity level calculations/estimations may be based on rules related to transportation network heuristics, including an understanding of possible impacts on the transportation network's operation and/or safety by messages of the type being inspected, and their severity.

Message sensitivity level calculations/estimations may be based on rules related to transportation network heuristics, including an understanding of possible impacts on the transportation network's operation and/or safety by messages of the type being inspected, and their likelihood.

According to further embodiments, an extent or procedure for suspicious message processing may also be context aware, and may be a function of assessed network sensitivity to the message, wherein the more sensitive the transportation network may be to message's impact, and/or the more likely is the impact, the more extreme or comprehensive may be the processing or handling of the suspicious message. Extremely low sensitivity level messages designated as suspicious or potentially malicious may simply be flagged for review and/or reported, and then allowed to continue to the message's target/destination transportation network management unit. High sensitivity level messages designated as suspicious or potentially malicious may be flagged and blocked from reaching their respective target management unit/asset, either until further review and/or processing has cleared and released the message, or until the message has been confirmed malicious and dropped.

A system for context aware Zero Trust (ZT) monitoring of communication between transportation network management units, in accordance with embodiments, may comprise monitoring agents to capture data packets carrying messages to and from transportation network management units of the transportation network, wherein at least one of the agents comprises: a message extraction module to extract message content from captured packets and to identify the source and destination of the message packets from their respective packet metadata; and, a ZT risk assessment module to, based on content within a captured message and a classification of the destination unit of the captured message, identify potential risk the captured message may generate within the transportation network upon reaching its destination unit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

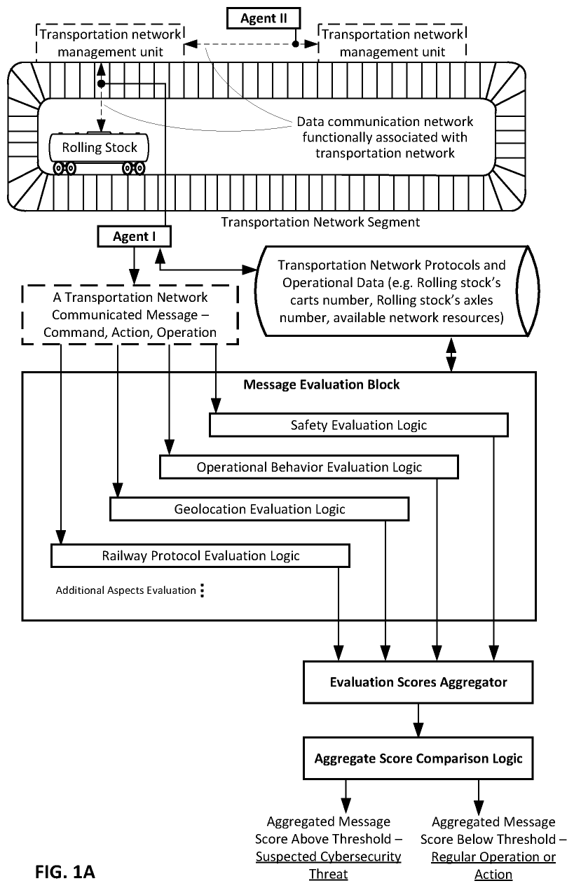

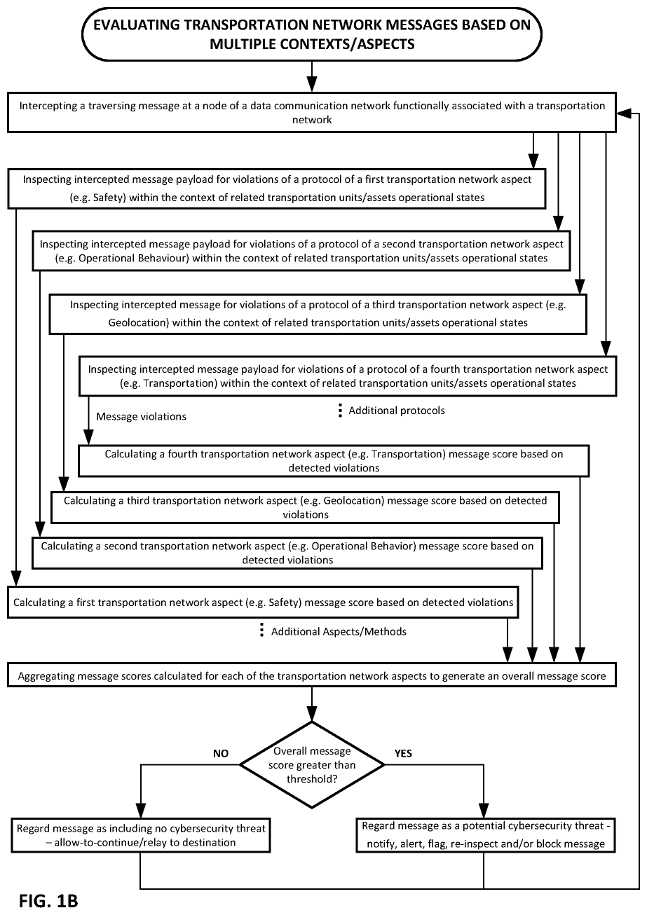

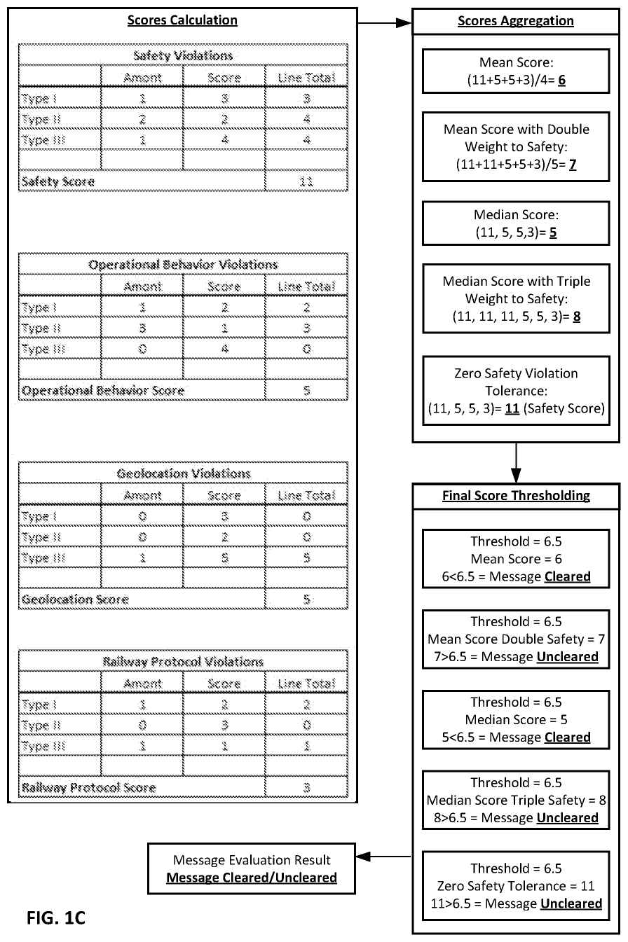

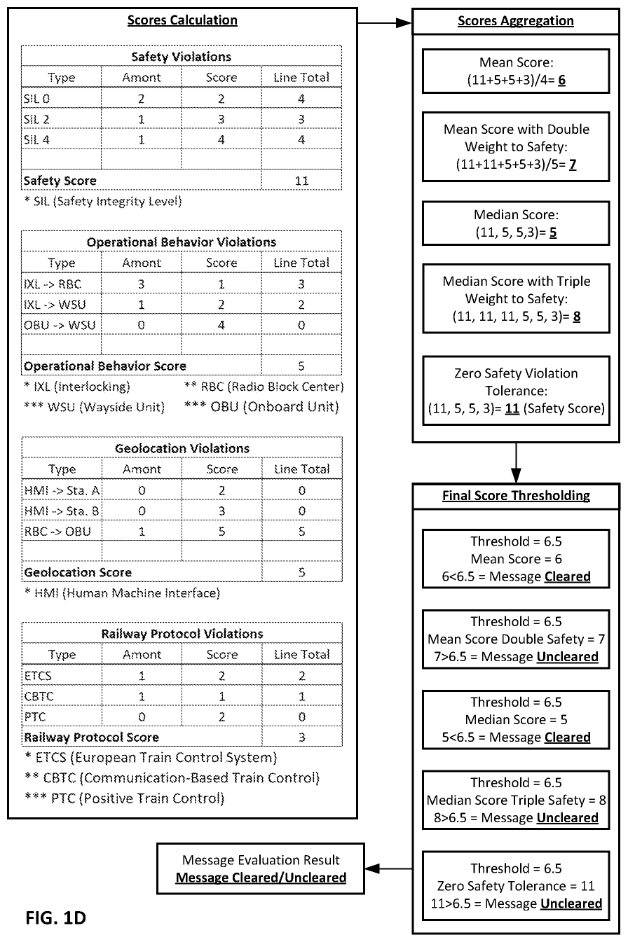

In FIG. 1A, there is shown a block diagram of an exemplary system for context aware zero trust monitoring of critical infrastructure data network messages, in accordance with some embodiments;

In FIG. 1B, there is shown a flowchart of the main steps executed as part of an exemplary method for context aware zero trust monitoring of critical infrastructure data network messages, in accordance with some embodiments;

In FIG. 1C, there is shown a schematic numeric calculation example of a message evaluation process, by an exemplary system for context aware zero trust monitoring of critical infrastructure data network messages, in accordance with some embodiments;

In FIG. 1D, there is shown a schematic numeric calculation example of a message evaluation process, by an exemplary system for context aware zero trust monitoring of critical infrastructure data network messages, wherein examples of actual railway transportation network message violation types are scored, in accordance with some embodiments;

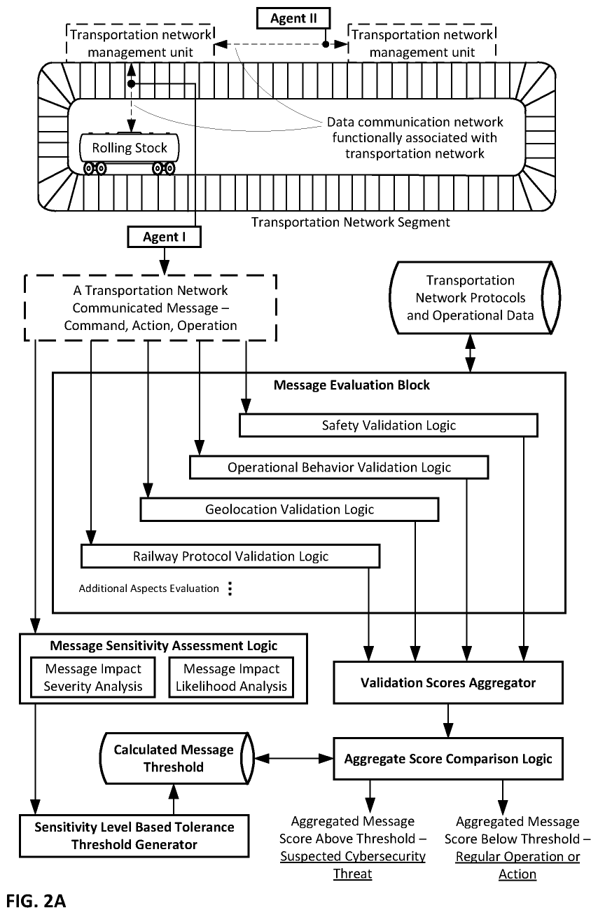

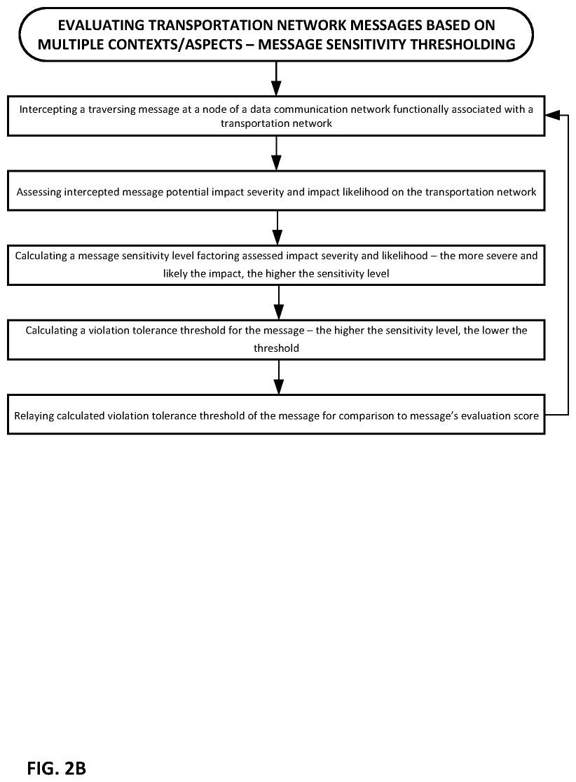

In FIG. 2A, there is shown a block diagram of an exemplary system for context aware zero trust monitoring of critical infrastructure data network messages, including a message sensitivity and threshold generation functionalities, in accordance with some embodiments;

In FIG. 2B, there is shown a flowchart of the main steps executed as part of an exemplary process for message sensitivity assessment and threshold generation, in accordance with some embodiments;

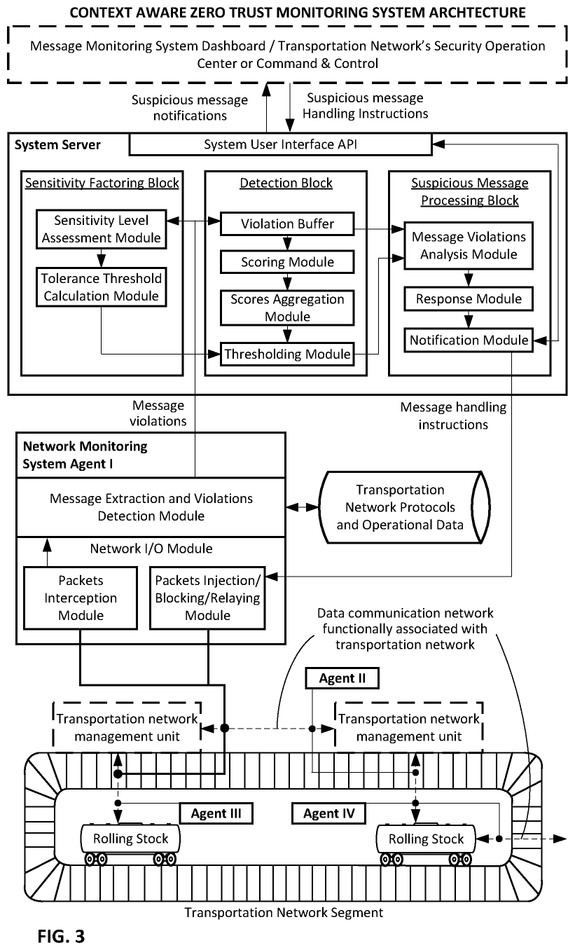

In FIG. 3 there is shown a block diagram of an exemplary system for context aware zero trust monitoring of critical infrastructure data network messages, including system architecture, modules and modules interrelations, in accordance with some embodiments;

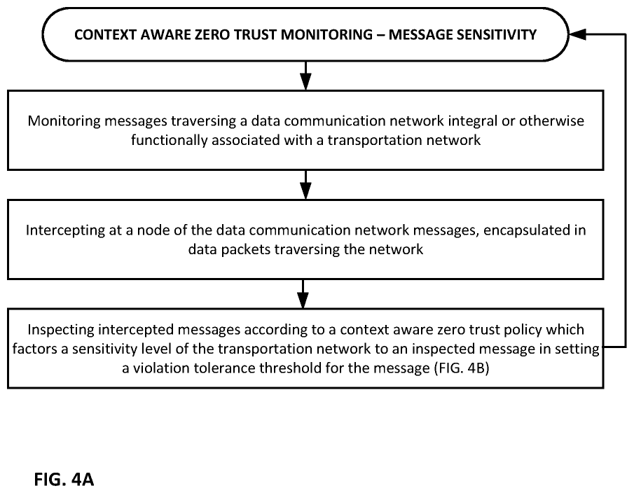

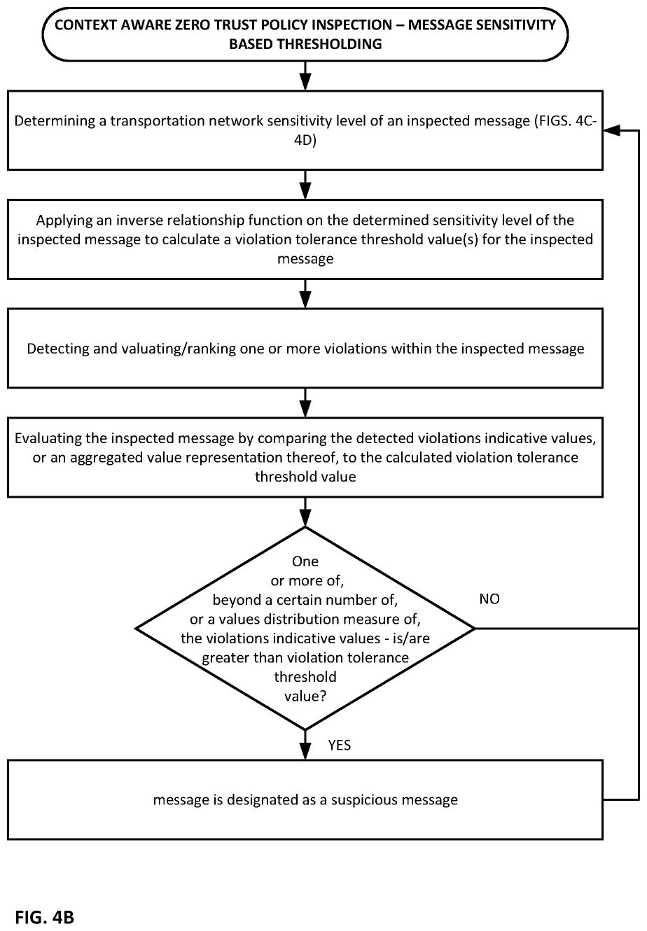

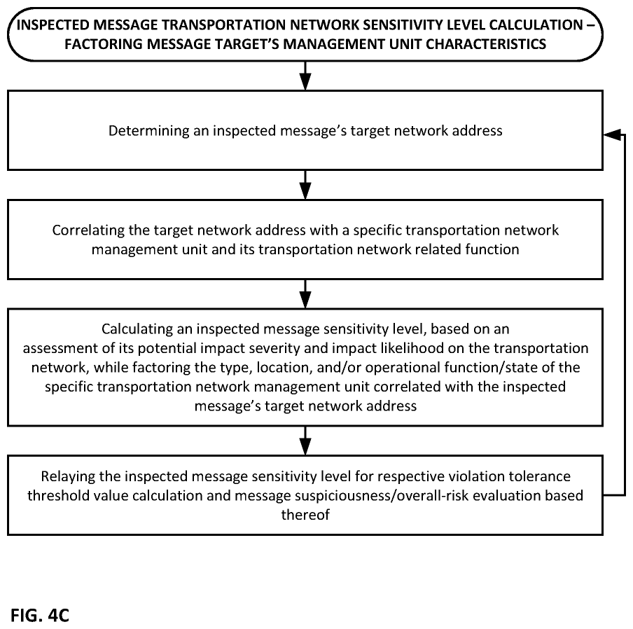

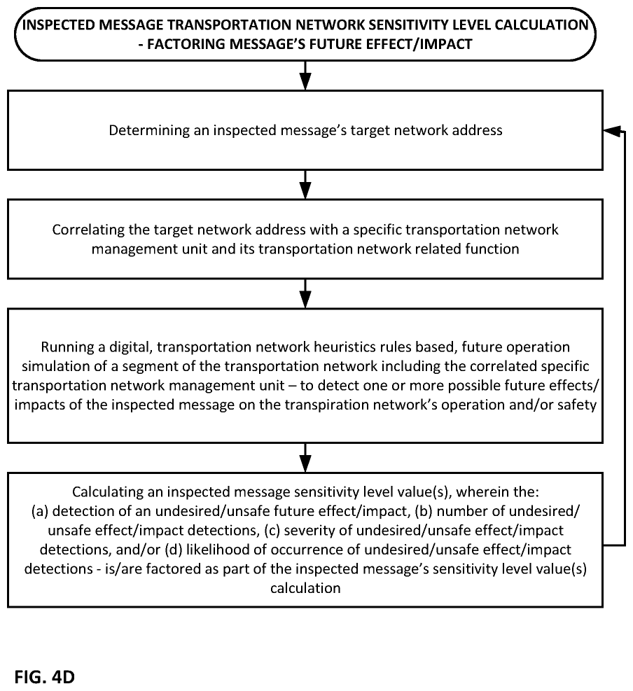

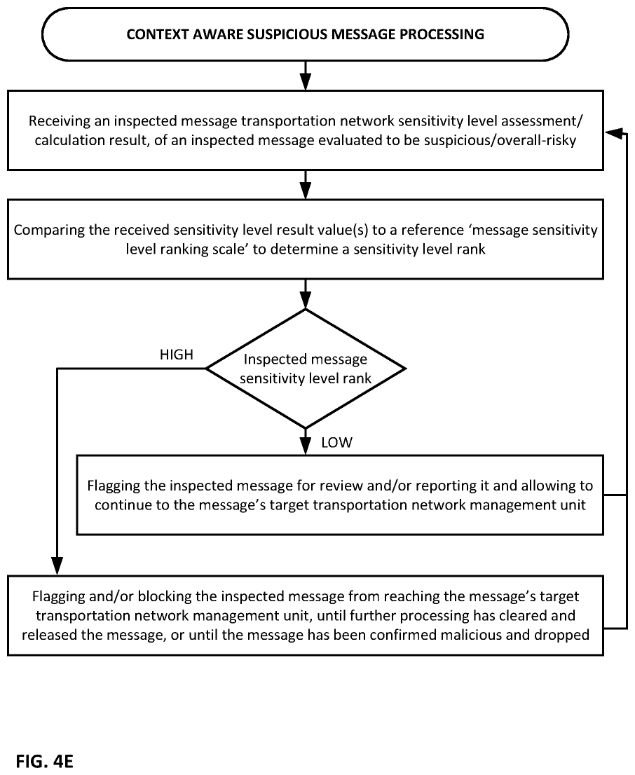

In FIG. 4A, there is shown a flowchart of the main steps executed as part of an exemplary process for message sensitivity based context aware zero trust monitoring, in accordance with some embodiments;

In FIG. 4B, there is shown a flowchart of the main steps executed as part of an exemplary process for context aware zero trust policy message inspection, including message sensitivity based thresholding, in accordance with some embodiments;

In FIG. 4C, there is shown a flowchart of the main steps executed as part of an exemplary process for inspected message transportation network sensitivity level calculation, factoring the message target's transportation network unit characteristics, in accordance with some embodiments;

In FIG. 4D, there is shown a flowchart of the main steps executed as part of an exemplary process for inspected message transportation network sensitivity level calculation, factoring future potential effect/impact of the message, in accordance with some embodiments;

In FIG. 4E, there is shown a flowchart of the main steps executed as part of an exemplary process for suspicious message processing and handling, in accordance with some embodiments;

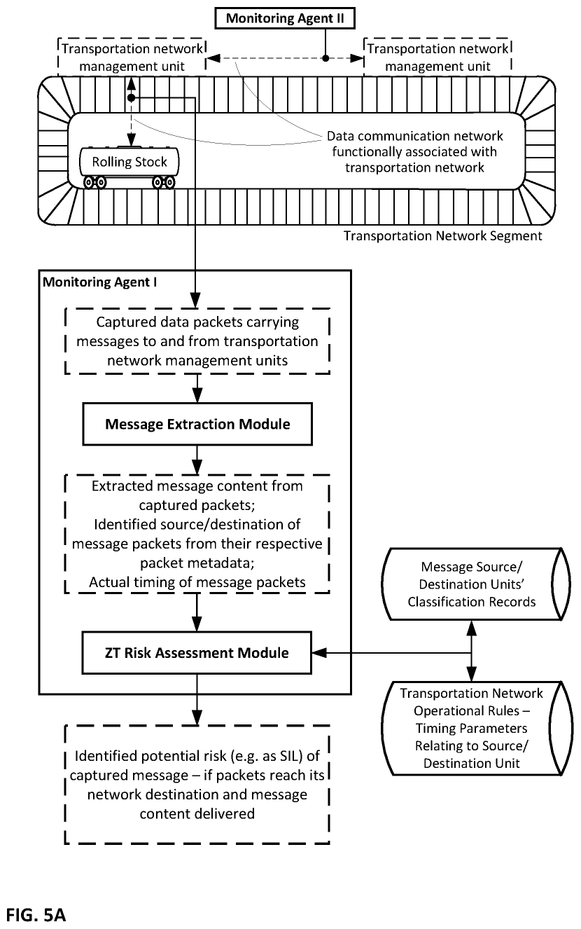

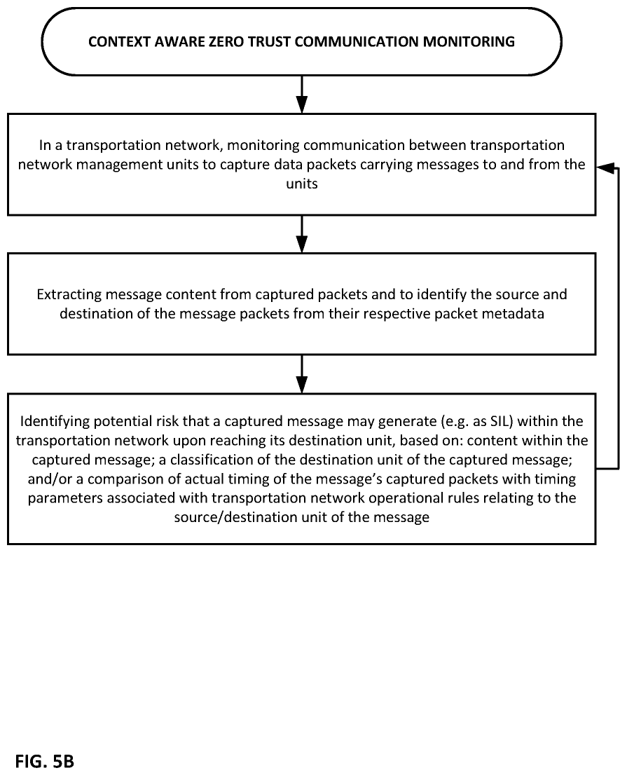

In FIG. 5A, there is shown a block diagram of an exemplary system for context aware zero trust monitoring of critical infrastructure data network messages, including message source/destination classification based, and message timing based, risk assessment, in accordance with some embodiments; and

In FIG. 5B, there is shown a flowchart of the main steps executed as part of an exemplary process for context aware zero trust monitoring of critical infrastructure data network messages, including message source/destination classification based, and message timing based, risk assessment, in accordance with some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, may for example take the form of an entirely hardware embodiment, an entirely software embodiment, or an embodiment including both hardware and software elements. Some embodiments may be implemented in software, which includes but is not limited to, any combination of: firmware, resident software, microcode, or the like. Some embodiments may be implemented in hardware, which includes but is not limited to, any combination of: a processor, memory and data storage components, a power source, communication circuitry, I/O interfaces, cards and devices, programmable arrays, systems on chip, or the like. Some embodiments may be implemented using a combination of hardware and software, which includes but is not limited to, any combination of the above hardware and software types and components.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention and is not intended to limit the invention to the specific embodiments illustrated by the figures or description below.

Lastly, the solutions, techniques and examples, in the following detailed description, are generally described in the context of providing cybersecurity to a transportation management system and more specifically to railway management and signaling systems. This, however, is not to limit the teachings herein, all or some of which may be likewise applicable to the digital protection and cybersecurity of various transportation related, and/or non-transportation related, critical infrastructure control/management networks and systems.

### I—Context Aware Zero Trust

Embodiments of the present invention may include methods, circuits, devices, systems and functionally associated machine executable code for context aware zero trust monitoring of messages traversing a data communication network integral or otherwise functionally associated with critical infrastructure, such as for example a transportation network. According to some embodiments, the monitored messages, encapsulated in data packets traversing the network, are intercepted at a node of the network by a message monitoring agent, which message monitoring agent may be implemented in dedicated hardware, in firmware, in software or by some combination of the three.

Intercepted messages may be inspected according to a context aware zero trust policy or methodology which intercepts and inspects substantially all messages traversing the data communication network, or substantially all messages to critical infrastructure assets such as transportation network management units, for network rule violations. The context aware zero trust policy or methodology may, in accordance with embodiments, regard by default any intercepted message as a potential cybersecurity threat, until the message is inspected and validated/cleared by the policy. Substantially all intercepted messages may be regarded as a potential cybersecurity threat, and inspected, regardless of their source and/or destination.

### II—Evaluating Transportation Network Messages Based on Multiple Contexts/Aspects

A context aware zero trust policy or methodology may, in accordance with embodiments, inspect and evaluate intercepted messages based on different aspects associated with the critical infrastructure being secured and/or its current context or state. A given message may accordingly be evaluated, and rated/scored, under each of the different aspects. The given message's scores for each of the evaluated aspects may then be aggregated to generate an overall score of the message that may be compared to a threshold value. An overall score greater than the threshold value may indicate that the given message could not be cleared and is to be regarded as a potential cybersecurity threat, whereas an overall score lesser than the threshold value may indicate that the given message has been cleared and is to be regarded as including no, or low, cybersecurity threat. Messages regarded as a potential cybersecurity threat may be notified, alerted, flagged, re-inspected and/or blocked; messages regarded as including no, or low, cybersecurity threat may be allowed to continue to their critical infrastructure (e.g. transportation network management) destination units/assets and trigger their intended action or operation.

According to some embodiments, messages traversing a data communication network integral or otherwise functionally associated with a transportation network, may for example be inspected and evaluated based on, or within the context or state of, the following aspects of the transportation network: (1) Geolocation of Communicating Transportation Network Units; (2) Operational Behavior of Communicating Transportation Network Units; (3) Potential Safety Rule Breach by Transportation Network Units Communications; and/or (4) Transportation Protocol Adherence of Communicating Transportation Network Units.

According to some embodiments, a given evaluated message may be scored, for a specific transportation network aspect, at least partially based on the types and number of its detected protocol violations associated with that aspect, wherein each detected violation type is scored in proportion to a predetermined sensitivity indicative value of the given evaluated message.

The message sensitivity value may be based on a combination of a determined severity level and a determined likelihood level—of the evaluated message's potential impact. The severity and likelihood levels may, in accordance with embodiments, be determined by: reading/determining the inspected/evaluated message's target network address: correlating the target network address with a specific transportation network management unit and its transportation network related function; and factoring the type, location, operational function, or operational state of the specific transportation network management unit correlated with the inspected message's target network address.

According to further embodiments, message sensitivity may be based on a combination of a determined severity level and a determined likelihood level of the evaluated message's potential simulated future impact, should the evaluated message reach its target transportation network management unit. The future/fast-forward simulation may for example factor—as part of determining the severity and likelihood levels—one or more simulated/predicted future operational statuses, states, or functions, of the specific transportation network management unit correlated with the target network address of the evaluated message, and/or of other transportation network management units communicating therewith.

### Geolocation

A geolocation context/state inspection and evaluation process of a given message may include assessing the inspected message within the context of the location of the communicating transportation network units/assets. The geolocations of a source transportation network unit/asset and a destination transportation network unit/asset, associated with a given Inspected message, may be evaluated for their adherence with a transportation network traffic protocol, including messages/communications triggered based on concurrent relative geolocations of the communicating units/assets.

For example, a transportation network traffic protocol of a railway transportation network, may demand for each train/rolling-stock unit approaching a rail station to message the rail station's control center when 10 kilometers away. An intercepted such ‘10 kilometers away’ message from a train/rolling-stock unit having a geolocation not 10 kilometers from any station, or alternatively having a geolocation 10 kilometers away from a rail station other than the inspected message's destination rail station, may be regarded as a geolocation evaluation violation or anomaly.

### Operational Behavior

An operational behavior context/state inspection and evaluation of a given message may include assessing the inspected message within the context of the operational activities, tasks and functions correlated with the communicating transportation network units/assets. The operational tasks and functions of a source transportation network unit/asset and/or a destination transportation network unit/asset, associated with a given Inspected message, may be evaluated for their adherence with a transportation network unit/asset type operation protocol. The protocol of a given transportation network unit/asset type, may include a listing of possible operational tasks, for execution by that given unit/asset type, triggered by a received message/communication from another unit/asset; and/or, a listing of possible operational tasks that may be relayed, as a message/communication, by that given unit/asset type for execution by other units/assets.

For example, a railway transportation network unit/asset type operation protocol, for the railway network's point machine unit/asset operating a railway turnout, may indicate that the source of any message for executing an operational activity/task associated with guiding a train from one track to another, must be a railway control center unit/asset. An intercepted message/communication, including a railway turnout command and having a point machine as its destination, may be regarded as an operational evaluation violation or anomaly if its source is a railway network light signal unit/asset—in contrary to the point machine's operation protocol demanding a railway control center. An intercepted message/communication, including a railway turnout command and having a railway network light signal unit/asset as its destination, may be regarded as an operational evaluation violation or anomaly, regardless of its source unit/asset—as it is in contrary to the railway network light signal's operation protocol.

### Safety Compliance

A safety compliance context/state inspection and evaluation of a given message may include assessing the inspected given message within the context of the safety compliance of operational activity, task and/or function command(s), that it is carrying for execution by its destination transportation network unit/asset. A message carried command(s) may accordingly be evaluated by comparison to the destination unit's/asset's safety protocol and/or its operational status, and optionally to the safety protocols and/or operational statuses of one or more other units/assets operationally associated with the destination unit/asset, to assure compliance of the command and no safety breach.

For example, a railway transportation network unit/asset safety protocol, for the railway network's control center operating the blocking and releasing of railway track segments, may indicate that when a train is present at a given block, that block cannot be released. An inspected message carried command for the release of a specific railway block by the message's destination railway network's control center, while the destination control center safety protocol indicates a train being present at that specific block, may be regarded as a safety compliance evaluation violation or anomaly, and a potential breach of the transportation network's passengers and assets safety.

As another example, a railway transportation network unit/asset safety protocol may demand the receipt of multiple/double similar command/request messages prior to the unit's/asset's execution of the message communicated command/request. An inspected message carried command for a specific operational activity, of the message's destination unit/asset, demanding the receipt of multiple/double similar/confirmation messages for its execution—for which no other message(s), traversing the data communication network or a specific node thereof and having similar command and destination, have been inspected—may likewise be regarded as a safety compliance evaluation violation or anomaly.

### Transportation Network Adherence

A transportation network context/state inspection and evaluation of a given message may include assessing the inspected given message within the context of the transportation network's protocol and the inspected message's adherence thereto. An inspected message and/or its carried command(s) may accordingly be evaluated by monitoring for, and inspecting, one or more additional messages or actions demanded by the transportation network protocol as a precondition to, or as part of, a specific transportation network operational action.

For example, a railway transportation network protocol may demand a predetermined, or dynamically set, number of actions, confirmations, pre-steps and/or communication handshakes, prior to the release of a railway track block or route. An inspected message, including a command for the release of such a railway track segment, may be regarded as a potential cyber threat until corresponding messages—collectively adhering to the network's transportation protocol demand for a railway track segment release action, for example, by carrying similar command confirmations to the same destination—have been inspected.

### III—Aggregating Transportation Network Message's Evaluation Ratings

According to some embodiments, inspecting a transportation network message may include its evaluation based on, or within the context or state of, any combination of the described aspects. For a given inspected message, one or more violations/anomalies may each be scored and recorded under each of the examined aspects; combining the given inspected message's scores within a specific aspect—for example, by adding, averaging, calculating a values distribution measure, and/or calculating a central tendency measure, of the scores—may constitute the given message's score for the specific aspect. A given message's scores in two or more different message scoring aspects may be aggregated or combined—for example, by adding, averaging, calculating a values distribution measure, and/or calculating a central tendency measure, of the scores—to generate an overall cybersecurity threat level score, for that given message.

Calculating an overall cybersecurity threat level of a given transportation network message may accordingly include a combination of: (a) Aggregating one or more violation/anomaly/breach scores associated with one of the evaluation aspects to generate an evaluation aspect score; (b) Repeating for each of the evaluation aspects; and/or (c) Aggregating the scores generated for each of the evaluation aspects to calculate an overall cybersecurity risk potential rating for the given communication.

### IV—Transportation Network Message Risk Assessment

According to some embodiments, the calculated overall cybersecurity threat level of a given transportation network message may be compared to a threshold value. A message having a low overall cybersecurity threat level, at or below the set threshold, may be regarded as ‘validated’ or ‘cleared’ and thus Ignored, relayed-to-destination, allowed-to-continue, labeled as safe and/or notified as such. A message having a high overall cybersecurity threat level, at or above the set threshold, may be regarded as ‘not cleared’ and thus blocked, buffered, reevaluated, labeled as a potential threat and/or notified as such.

### V—Future Effect Risk Simulation

According to some embodiments, a critical infrastructure future state simulation engine may predict a future state or context of the infrastructure's operational units/assets. For example, a railway transportation network infrastructure future state simulation engine may predict the locations/positions, and/or the operational states/orientations, of at least some of the railway transportation network's units/assets, or of units/assets within a specific relevant node of the network.

Simulation results, at one or more future timepoints, may be compared to one or more relevant critical infrastructure protocols or railway transportation network protocols as described herein—to predict the possible future effect(s) and impact(s) of an inspected message continuing to its target/destination unit/asset and calculate a message cybersecurity risk level factoring same. The future simulation, in accordance with embodiments, may predict a message's effect on the infrastructure/transportation-network units/assets at one or more pre-set, dynamically-set, arbitrary, and/or intermittent future timepoints/time-segments. The future simulation, in accordance with embodiments, may predict an inspected message's effect on the infrastructure/transportation-network units/assets, at one or more future timepoints/time-segments determined based on an estimated/projected destination unit/asset arrival time, of the message being inspected.

### VI—Inspected Message Sensitivity

According to some embodiments, intercepted messages may be inspected according to a context aware zero trust policy or methodology which factors a sensitivity level of the transportation network to the inspected message in setting an anomaly/violation tolerance threshold for the message.

According to some embodiments of the present invention, there may be an inverse relationship between a message's assigned or otherwise associated network sensitivity level and a resulting or corresponding anomaly/violation tolerance threshold applied when evaluating the message within a context aware zero trust evaluation methodology. For example, the more sensitive the transportation network may be to a given message, the lower may be set the threshold for detected violations or anomalies in the message, or its carrier data packets, before the message is designated as a suspicious message, potentially constituting a cyberattack or a cyber-accident. An inspected message's sensitivity level may be calculated or estimated as a continues value, or may be rounded/quantized to one of two or more discrete sensitivity level values.

Anomaly/violation tolerance thresholds for messages, according to embodiments of the present invention, may also be either continuous value, discrete values or rule based. According to some embodiments, each sensitivity level value may result in a corresponding tolerance threshold value, either calculated as a direct function of the sensitivity level value or optionally based on records in a data table.

### VII—Inspected Message Sensitivity—Impact Severity

The sensitivity level calculations/estimations may be based on rules related to transportation network heuristics, including an understanding of possible impacts on the transportation network's operation and/or safety by messages of the type being inspected, and their severity. To that end, inspection of messages according to embodiment of the present invention may include a correlation of the message's target/destination network address with a specific transportation network management unit/asset and its transportation network related function. Correlation may be achieved through network discovery, table lookup and/or other computerized means of determining which transportation unit has a data network connection at the inspected message's target/destination address.

According to further embodiments, a current geolocation and/or current state of the inspected message's target/destination transportation management unit/asset may be factored when calculating and or otherwise assigning a sensitivity level to the message. For example, messages addressed to transportation management units/assets controlling currently moving rolling stock may be assigned a higher sensitivity level than a message of the same message type but addressed to a transportation management unit controlling parked rolling stock disconnected from drive train power.

### VIII—Inspected Message Sensitivity—Impact Likelihood

According to some embodiments, in addition to potential transportation network impact and its severity, likelihood of occurrence of the possible “impact” on the transportation network, should the message be malicious, is another factor used in assigning to a message a network sensitivity level. The less likely the probability of a bad or harmful impact on the transportation network by a malicious message of the inspected message's type, the lower the sensitivity level assigned to the inspected message, and the higher the corresponding anomaly/violation tolerance for that message is set.

### IX—Suspicious Message Processing

According to further embodiments, an extent or procedure for suspicious message processing may also be context aware, and may be a function of assessed network sensitivity to the message, wherein the more sensitive the transportation network may be to message's impact, and/or the more likely is the impact, the more extreme or comprehensive may be the processing or handling of the suspicious message. Extremely low sensitivity level messages designated as suspicious or potentially malicious may simply be flagged for review and/or reported, and then allowed to continue to the message's target/destination transportation network management unit. High sensitivity level messages designated as suspicious or potentially malicious may be flagged and blocked from reaching their respective target management unit/asset, either until further review and/or processing has cleared and released the message, or until the message has been confirmed malicious and dropped.

During normal operation of a transportation network according to embodiments of the present invention, substantially all messages to critical network management units are intercepted and checked for infrastructure/transportation-network protocol rule violations and or other anomalies, such as for example: (1) target address of message is empty, (2) packet time stamps violate packet TTL rules, (3) irregularity in timing or indicated source of the message, etc. Each detected violation type and or anomaly type may be associated with a different violation value. Actual violation values of each of multiple detected violations for the same message may be aggregated/combined and compared to the message's previously assigned anomaly/violation tolerance level. If the aforementioned message's inspection process results in the message's combined violation values not exceeding the tolerance threshold, the message may not even be flagged as suspicious and may be released. If the inspection process leads to the message being assigned a violation level value exceeding its tolerance threshold, the message may be tagged suspicious and processed in accordance with the previously mentioned suspicious message handling methodologies.

According to embodiments of the present invention, a set of one or more of the monitoring agents, as described herein, may be coupled to respective infrastructure/transportation management network units and adapted to each collect and relay signals/data-streams indicative of the units' recent communications and activity and/or recent/current operation state(s)/status(es).

According to some embodiments, system ‘agents’, as described herein, may take the form of, or be implemented as: a software agent/application, a dedicated function embedded system, a system on chip (SoC), a multi-function computer or server and/or any software and/or hardware including a combination of the above listed computing system/component/module/engine types, or any computing system/component type to be devised in the future. According to some embodiments, the cybersecurity agents described in any of the embodiments herein, may use deep-packet inspection for network packets to detect malicious activity or exploits—such as protocol vulnerabilities, operating system vulnerabilities and more.

Reference is now made to FIG. 1A, where there is shown a block diagram of an exemplary system for context aware zero trust monitoring of critical infrastructure data network messages, in accordance with some embodiments.

In the figure, system agents are shown to monitor messages traversing a data communication network integral or otherwise functionally associated with a railway transportation network. Messages communicated between operational units and rolling stocks of the shown railway transportation network segment/node are intercepted by the agents and inspected/evaluated for violations of multiple referenced protocols, each associated with a different aspect of the railway transportation network-safety, operational behavior, geolocation of rolling stock vehicles, and transportation rules and constrains.

A message evaluation block, implemented on a system server, detects violations within an agent intercepted message, or alternatively, receives a listing of detected violations based on an evaluation executed by the message intercepting agent. Specific evaluation logics, for each of the message evaluation aspects, are shown to process the detected message violations of their respective/handled aspect and calculate a message score for that aspect. A given message's aspect-score may be proportional to a combination of: (a) the number of detected violations within the evaluated aspect—the more violations within the aspect the greater the overall aspect score; and (b) the type of violations detected within the aspect—specific violation types contribute more to the overall aspect score.

The message's multiple aspect-scores are then relayed to the shown evaluation score aggregator and processed to generate an overall message score factoring each of the aspect-scores, optionally, while allocating different weights to at least some of the different aspect scores. For example, a safety aspect score may be given double the weight of other aspects' scores, as part of the message's overall score calculation.

The overall message score, or ‘aggregated score’, is then compared, by an aggregate score comparison logic, to a threshold value. If the aggregated message score is above the threshold value—the message is regarded as a suspected cybersecurity threat and remains ‘uncleared’ under the system's zero trust policy. If, on the other hand, the aggregated message score is below the threshold value—the message is regarded as a regular operation or action and is thereby ‘cleared’ under the system's zero trust policy.

Reference is now made to FIG. 1B, where there is shown a flowchart of the main steps executed as part of an exemplary method for context aware zero trust monitoring of critical infrastructure data network messages, in accordance with some embodiments.

In the figure, the following process flow and steps are shown: (1) Intercepting a traversing message at a node of a data communication network functionally associated with a transportation network; (2) Inspecting intercepted message payload for: (a) violations of a protocol of a first transportation network aspect (e.g. Safety) within the context of related transportation units/assets operational states, (b) violations of a protocol of a second transportation network aspect (e.g. Operational Behaviour) within the context of related transportation units/assets operational states, (c) violations of a protocol of a third transportation network aspect (e.g. Geolocation) within the context of related transportation units/assets operational states, (d) violations of a protocol of a fourth transportation network aspect (e.g. Transportation) within the context of related transportation units/assets operational states, and optionally (e) violations of additional protocol(s); (3) Calculating: (a) a first transportation network aspect (e.g. Safety) message score based on detected violations, (b) a second transportation network aspect (e.g. Operational Behavior) message score based on detected violations, (c) a third transportation network aspect (e.g. Geolocation) message score based on detected violations, (d) a fourth transportation network aspect (e.g. Transportation) message score based on detected violations, and optionally (e) message scores for additional transportation network aspect(s); (4) Aggregating message scores calculated for each of the transportation network aspects to generate an overall message score; (5) Comparing the overall message score to a threshold, if overall message score is greater than threshold then (a) regard message as a potential cybersecurity threat—notify, alert, flag, re-inspect and/or block message, if overall message score is lesser than threshold then (b) regard message as including no cybersecurity threat—allow-to-continue/relay to destination; and (6) Return to start, intercepting next message to inspect.

Reference is now made to FIG. 1C, where there is shown a schematic numeric calculation example of a message evaluation process, by an exemplary system for context aware zero trust monitoring of critical infrastructure data network messages, in accordance with some embodiments.

In the figure, an exemplary inspected message's Scores Calculation is shown to include four railway transportation network aspects. Under each aspect—Safety, Operational Behavior, Geolocation and Railway/Transportation—a set of possible associated violation types, I, II and III, are listed, along with their number of occurrences within the inspected message. Each violation type has a corresponding score which is multiplied by the number of its occurrences to yield the line total, line totals are then summed to give the total score of the aspect.

As part of Scores Aggregation, a few possible examples of formulas/schemes for calculating an overall message score based on its aspect scores are shown. Shown formulas/schemes include: calculating a mean score of the aspect scores, calculating a mean score while allocating double weight to the safety aspect, calculating a median score, calculating a median score while allocating triple weight to the safety aspect, and a zero tolerance to safety violation scheme that initially considers whether any safety violations were detected.

In the Final Score Thresholding section, the overall scores of the message—calculated using each of the different formulas/schemes exemplified—are compared to a predetermined threshold. If the overall message score is lesser than the threshold value the message is cleared, on the other hand, if the overall message score is greater than the threshold value the message remains uncleared and handled as a potential threat. It is shown that depending on the type of aggregation formula/scheme utilized, the same set of message aspect scores yielded different results and rendered the message ‘cleared’ in some of the cases (Mean and Median schemes), while rendering it ‘uncleared’ in the others (Mean & Double Safety, Median and Triple Safety and Zero Safety Tolerance).

In the Zero Safety Tolerance scheme the threshold value (6.5) is shown to be compared to the calculated value of the safety aspect (11). A Zero Safety Tolerance scheme in accordance with embodiments, may render a message ‘unclear’ if an above threshold value—or alternatively if any positive value—is calculated for a safety aspect of the transportation-network/infrastructure, as part of the message's evaluation. A message found to have a below threshold—or an absolute zero (0)—safety aspect score, may then be evaluated under other aspects, as described herein, prior to completing its evaluation and being rendered ‘clear’.

Reference is now made to FIG. 1D, where there is shown a schematic numeric calculation example of a message evaluation process, by an exemplary system for context aware zero trust monitoring of critical infrastructure data network messages, wherein examples of actual railway transportation network message violation types are scored, in accordance with some embodiments.

In the figure, the following exemplary railway transportation network message violation types are listed and scored: (1) Safety Violations—SIL (Safety Integrity Level) 0 violations, SIL 2 violations and SIL 4 violations—wherein the higher the SIL value, the higher the allocated violation score; (2) Operational Behavior Violations—an IXL (Interlocking) to RBC (radio Block Center) message violations type is allocated a low score of 1; an IXL to WSU (Wayside Unit) message violations type is allocated a higher score of 2; and an OBU (Onboard Unit) to WSU message violations type is allocated the highest score of 4; (3) Geolocation Violations—an HMI (Human Machine Interface) to a first railway station (Station A) message violations type is allocated a low score of 2; an HMI to a second railway station (Station B) message violations type is allocated a higher score of 3; and an RBC to an OBU message violations type is allocated with the highest score of 5; and (4) Railway Protocol Violations—an ETCS (European Train Control System) message violations type is allocated a score of 2; and a CBTC (Communication-Based Train Control) message violations type is allocated a lower score of 1.

As exemplified in the figure, a message violations type's allocated score, in accordance with embodiments, may depend on, factor, or be calculated based on, any combination of: (1) the type (e.g. ETCS, CBTC), (2) the severity/urgency (e.g. SIL 0, SIL 2, SIL 4), (3) the sender and/or recipient (e.g. IXL to RBC, IXL to WSU, OBU to WSU, HMI to Sta. A, HMI to Sta. B, RBC to OBU), and/or (4) any other characteristic—of the violation including message.

Reference is now made to FIG. 2A, where there is shown a block diagram of an exemplary system for context aware zero trust monitoring of critical infrastructure data network messages, including a message sensitivity and threshold generation functionalities, in accordance with some embodiments.

In the figure, the system of FIG. 1A, or a system server thereof, is shown to further include a message sensitivity assessment logic for determining a sensitivity level for a received message being evaluated. The sensitivity level assessment factors the outcomes of an analysis of: (1) the severity of the potential impact, of the evaluated message, on the associated critical infrastructure or transportation network; and (2) the likelihood of the potential impact, of the evaluated message, actually occurring in, and/or actually affecting, the associated critical infrastructure or transportation network.

The shown ‘sensitivity-level based tolerance threshold generator’ then calculates and registers a threshold value specifically for the message being evaluated, by applying an inverse relationship function on the predetermined message sensitivity indicative value—the higher the sensitivity level, the lower the yielded threshold value for that message. Two or more messages, found to include substantially the same numbers and types of violations, may accordingly be differently regarded by the system—for example, one may be cleared while the other remains uncleared—due to their different sensitivity levels and, thus different, thresholding values.

The system's aggregate score comparison logic is shown to reference the evaluated message's registered specific threshold and compare it to the aggregated violations score of that message. If the aggregated violations score threshold is greater than the corresponding message-specific threshold value, the message is rendered ‘uncleared’; if, on the other hand, the aggregated violations score threshold is lesser than the corresponding message-specific threshold value, the message is rendered ‘cleared’.

Reference is now made to FIG. 2B, where there is shown a flowchart of the main steps executed as part of an exemplary process for message sensitivity assessment and threshold generation, in accordance with some embodiments.

In the figure, the following process flow and steps are shown: (1) Intercepting a traversing message at a node of a data communication network functionally associated with a transportation network; (2) Assessing intercepted message potential impact severity and impact likelihood on the transportation network; (3) Calculating a message sensitivity level factoring assessed impact severity and likelihood—the more severe and likely the impact, the higher the sensitivity level; (4) Calculating a violation tolerance threshold for the message—the higher the sensitivity level, the lower the threshold; and (5) Relaying calculated violation tolerance threshold of the message for comparison to message's evaluation score.

Reference is now made to FIG. 3, where there is shown a block diagram of an exemplary system for context aware zero trust monitoring of critical infrastructure data network messages, including system architecture, modules and modules interrelations, in accordance with some embodiments.

In the figure, network monitoring system agents are shown to monitor communications between operational/management units and rolling stocks of a transportation network segment or node. A packets interception module of Agent I is shown to intercept packets traversing the communication network. The agent's message extraction and violations detection module, extracts a message encapsulated in the intercepted data packet and analyses the message data and/or metadata to detect violations, by reference of, and comparison to records of, a database including railway transportation network protocols and operational data.

Detected message violations are relayed to a system server. The server's detection block buffers the arriving message violations, evaluates the railway transportation network aspects, types, and number of violations in the message and calculates a message score for each of the evaluated aspects. The shown scores aggregation module aggregates the scoring module's calculated aspect scores, as described herein, to generate an overall message violations score, relayed to the thresholding module.

The server's sensitivity factoring block assesses the sensitivity of the message to generate a message sensitivity indicative value, and a tolerance threshold calculation module applies an inverse relationship function on the message sensitivity indicative value to calculate a threshold value specific to the sensitivity assessed message. The calculated message-specific threshold is then relayed to the thresholding module for comparison to the overall violations score of the same message.

The server is shown to further include a suspicious message processing block. Buffered message violations and message overall score thresholding outcome (i.e. ‘cleared’, ‘uncleared’) are collectively, and/or separately, analyzed by the shown message violations analysis module to infer an overall risk/threat/threat-type level of the message. The shown response module elects a set of one or more response actions or recommendations, corresponding to the overall risk/threat/threat-type. The shown notification module notifies, through a system user API, a ‘message monitoring system dashboard’, a ‘security operation center’ of the railway transportation network, and/or a ‘command and control center’ of the railway transportation network—of messages determined suspicious and optionally of the characteristics/basis for the suspicion, such as the types and number of detected violations associated with each suspicious message. Notifications may further include one or more response, mitigation and/or prevention recommendations—specifically matched to the suspicion level and violation characteristics of the suspected message. Suspicious message handling instructions may be automatically triggered by the suspicious message processing block; or generated/relayed by it based on handling instructions received from the ‘message monitoring system dashboard’ or the ‘security operation center’/‘command and control center’ of the railway transportation network. Message handling instructions are relayed to the system agent's network I/O module for enforcement, for example, by their re-encapsulation, network injection, or further relaying to their original target, if the message was cleared; or, their blocking, sinking, or buffering, if the message was uncleared.

Reference is now made to FIG. 4A, where there is shown a flowchart of the main steps executed as part of an exemplary process for message sensitivity based context aware zero trust monitoring, in accordance with some embodiments.

In the figure, the following process flow and steps are shown: (1) Monitoring messages traversing a data communication network integral or otherwise functionally associated with a transportation network; (2) Intercepting at a node of the data communication network messages, encapsulated in data packets traversing the network; and (3) Inspecting intercepted messages according to a context aware zero trust policy which factors a sensitivity level of the transportation network to an inspected message in setting a violation tolerance threshold for the message (see FIG. 4B).

Reference is now made to FIG. 4B, where there is shown a flowchart of the main steps executed as part of an exemplary process for context aware zero trust policy message inspection, including message sensitivity based thresholding, in accordance with some embodiments.

In the figure, the following process flow and steps are shown: (1) Determining a transportation network sensitivity level of an inspected message (see FIGS. 4C-4D); (2) Applying an inverse relationship function on the determined sensitivity level of the inspected message to calculate a violation tolerance threshold value(s) for the inspected message; (3) Detecting and valuating/ranking one or more violations within the inspected message; (4) Evaluating the inspected message by comparing the detected violations indicative values, or an aggregated value representation thereof, to the calculated violation tolerance threshold value; (5) If one or more of, beyond a certain number of, or a values distribution measure of, the violations indicative values—is/are greater than violation tolerance threshold value, then designate the message as suspicious; and (6) return to start, to determine next message sensitivity.

Reference is now made to FIG. 4C, where there is shown a flowchart of the main steps executed as part of an exemplary process for inspected message transportation network sensitivity level calculation, factoring the message target's transportation network unit characteristics, in accordance with some embodiments.

In the figure, the following process flow and steps are shown: (1) Determining an inspected message's target network address; (2) Correlating the target network address with a specific transportation network management unit and its transportation network related function; (3) Calculating an inspected message sensitivity level, based on an assessment of its potential impact severity and impact likelihood on the transportation network, while factoring the type, location, and/or operational function/state of the specific transportation network management unit correlated with the inspected message's target network address; and (4) Relaying the inspected message sensitivity level for respective violation tolerance threshold value calculation and message suspiciousness/overall-risk evaluation based thereof.

Reference is now made to FIG. 4D, where there is shown a flowchart of the main steps executed as part of an exemplary process for inspected message transportation network sensitivity level calculation, factoring future potential effect/impact of the message, in accordance with some embodiments.

In the figure, the following process flow and steps are shown: (1) Determining an inspected message's target network address; (2) Correlating the target network address with a specific transportation network management unit and its transportation network related function; (3) Running a digital, transportation network heuristics rules based, future operation simulation of a segment of the transportation network including the correlated specific transportation network management unit—to detect one or more possible future effects/impacts of the inspected message on the transpiration network's operation and/or safety; and (4) Calculating an inspected message sensitivity level value(s), wherein the: (a) detection of an undesired/unsafe future effect/impact, (b) number of undesired/unsafe effect/impact detections, (c) severity of undesired/unsafe effect/impact detections, and/or (d) likelihood of occurrence of undesired/unsafe effect/impact detections—is/are factored as part of the inspected message's sensitivity level value(s) calculation.

Reference is now made to FIG. 4E, where there is shown a flowchart of the main steps executed as part of an exemplary process for suspicious message processing and handling, in accordance with some embodiments.

In the figure, the following process flow and steps are shown: (1) Receiving an inspected message transportation network sensitivity level assessment/calculation result, of an inspected message evaluated to be suspicious/overall-risky; (2) Comparing the received sensitivity level result value(s) to a reference ‘message sensitivity level ranking scale’ to determine a sensitivity level rank; (3) if the inspected message sensitivity level rank is high, then (a) Flagging and blocking the inspected message from reaching the message's target transportation network management unit, until further processing has cleared and released the message, or until the message has been confirmed malicious and dropped; if the inspected message sensitivity level rank is low, then (b) Flagging the inspected message for review and/or reporting it and allowing to continue to the message's target transportation network management unit; and (4) return to start, to receive next message sensitivity.

Reference is now made to FIG. 5A, where there is shown a block diagram of an exemplary system for context aware zero trust monitoring of critical infrastructure data network messages, including message source/destination classification based, and message timing based, risk assessment, in accordance with some embodiments.

In the figure, monitoring agents are shown to monitor transportation network management/operational units communications, capturing data packets carrying messages to and from transportation network management units of the transportation network. Monitoring agent I, shown in further detail, includes a message extraction module to extract message content from the captured packets and to identify the source and destination of the message packets from their respective packet metadata. A ZT risk assessment module identifies a potential risk the captured message may generate within the transportation network upon reaching its destination unit, at least partially based on any combination of: (1) content within the message's packets' payload; (2) the message's identified transportation network source/destination unit(s) and its/their database referenced classification type/group/cluster (e.g. critical unit, high risk unit, low risk, etc.); and/or (3) a comparison of actual timing of specific captured messages/messages-packets with database referenced timing parameters associated with transportation network operational rules relating to the source unit or destination unit of the message.

Reference is now made to FIG. 5B, where there is shown a flowchart of the main steps executed as part of an exemplary process for context aware zero trust monitoring of critical infrastructure data network messages, including message content/packets-payload data based, message source/destination classification based, and message timing based, risk assessment, in accordance with some embodiments.

In the figure, the following steps are shown: (1) Monitoring communication between management and/or operational units of a transportation network to capture data packets carrying messages to and from the units; (2) Extracting message content from captured packets to identify the source and destination of the message packets from their respective packet metadata; and/or (3) Identifying potential risk that a captured message may generate (e.g. as Security Integrity Level (SIL)) within the transportation network upon reaching its destination unit, based on: content within the captured message; a classification of the destination unit of the captured message; and/or a comparison of actual timing of the message's captured packets with timing parameters associated with transportation network operational rules relating to the source/destination unit of the message.

According to some embodiments of the present invention, a system for context aware Zero Trust (ZT) monitoring of communication between transportation network management units may comprise monitoring agents to capture data packets carrying messages to and from transportation network management units of the transportation network, wherein at least one of the agents comprises: a message extraction module to extract message content from captured packets and to identify the source and destination of the message packets from their respective packet metadata; and, a ZT risk assessment module to, based on content within a captured message and a classification of the destination unit of the captured message, identify potential risk the captured message may generate within the transportation network upon reaching its destination unit.

According to some embodiments, the ZT risk assessment module may identify risk by comparing actual timing of specific captured messages/message-packets with timing parameters associated with transportation network operational rules relating to the source unit or destination unit of the message.

According to some embodiments, the comparison of actual timing to timing parameters may include: (a) absolute location of message source or message destination; (b) relative distance of either message source or message destination to some network element, including between source and destination; and/or (c) relative timing between capture of related packets.

According to some embodiments, the timing parameters associated with transportation network operational rules may be retrieved or extracted from time tabling of a periodical train schedule.

According to some embodiments, the ZT risk assessment module may identify risk by comparing a simulation of an operational result of a message of a captured packet arriving at its destination relative to the transportation network operational rules.

According to some embodiments, as part of identifying risk, the ZT risk assessment module may calculate a Security Integrity Level (SIL) based on the comparison results' similarity level and the identified potential risk of the message packets increases or decreases inversely to the calculated SIL.

According to some embodiments, the ‘timing parameters associated with transportation network operational rules’ may be associated with two or more different aspects of the transportation network, the SIL may be separately assessed and scored for each of the aspects, and the scores of the different aspects may be collectively aggregated to generate a combined captured message SIL level score.

According to some embodiments, aggregating aspect scores may be based on the calculation of a central tendency measure of the scores. According to some embodiments, aggregating aspect scores may include increasing the relative weight of a score(s) associated with a specific transportation network aspect, in comparison to the weight of a score associated with another/other transportation network aspect(s). According to some embodiments.

According to some embodiments, as part of identifying risk, the ZT risk assessment module may also factor a current state of one or more rolling stock functionally associated with the destination units. According to some embodiments, the ZT risk assessment module may also factor a predicted future state of one or more rolling stock functionally associated with the destination units. According to some embodiments, the predicted future state may be generated using a simulation of the transportation network, while factoring the rolling stock current state as the start of a simulation with simulation state evolution based on rolling stock compliance with the captured messages.

According to some embodiments, the ZT risk assessment module may calculate a ZT risk level score based on the identified risk or risk level.

According to some embodiments, as part of identifying risk, the ZT risk assessment module may also factor a current state of one or more transportation network trackside units functionally associated with the destination units. According to some embodiments, the ZT risk assessment module may also factor a predicted future state of one or more trackside units functionally associated with the destination units. According to some embodiments, the predicted future state may be generated using a simulation of the transportation network, while factoring the trackside unit's current state as the start of a simulation with simulation state evolution based on trackside unit compliance with the captured messages. According to some embodiments, the trackside unit may be selected from the group consisting of: wayside, point machine, level cross, signal, train detection sensor, interlocking (IXL) and/or any other transportation network component/unit on, or at the proximity of, the transportation network's course/path/track/rail-track.

According to some embodiments of the present invention, a method for context aware Zero Trust (ZT) monitoring of communication between transportation network management units, may comprise: monitoring communication between the transportation network management units to capture data packets carrying messages to and from the units; extracting message content from captured packets to identify the source and destination of the message packets from their respective packet metadata; and identifying potential risk that a captured message may generate within the transportation network upon reaching its destination unit, based on content within the captured message and a classification of the destination unit of the captured message.

According to some embodiments, identifying potential risk that a captured message may generate may include comparing actual timing of specific captured messages with timing parameters associated with transportation network operational rules relating to the source unit or destination unit of the message.

According to some embodiments, identifying risk may include calculating a Security Integrity Level (SIL) based on the comparison results' similarity level and the identified potential risk of the message packets increases or decreases inversely to the calculated SIL.

According to some embodiments of the present invention, a system for context aware zero trust monitoring, may include monitoring agents functionally associated with and monitoring message communications to and from each of one or more transportation network management units regulating components of the rail transportation network, each of said agents including: a transportation network message evaluation logic to detect adherence violations, of an agent intercepted message, from a set of protocols, each protocol associated with a different transportation network aspect; and a communication module for relaying indications of the evaluated message's detected violations to a system server, each violation indication including: (a) the transportation network aspect associated with the detected violation and (b) a violation type indicator matching the detected violation, selected from within two or more violation types of that aspect.

According to some embodiments, the system server may further include a scoring module for calculating for the evaluated message, under each of the transportation network evaluated aspects, a score based on the types and number of detected protocol violations associated with that aspect; a scores aggregation module for aggregating the evaluated message's scores under each of the evaluated aspects to generate an aggregated message score; and a thresholding module to compare the aggregated message score to a message adherence violation score threshold and validate the message if the aggregated message score is lesser than its adherence violation score threshold.

According to some embodiments, aggregating aspect scores may be based on the calculation of a central tendency measure of the scores.

According to some embodiments, aggregating aspect scores may include increasing the relative weight of a score associated with a specific transportation network aspect, in comparison to the weight of a score associated with another transportation network aspect.

According to some embodiments, the specific transportation network aspect score whose relative weight may be increased is the transportation network's safety aspect.

According to some embodiments, the threshold may be calculated by applying an inverse relationship function on a predetermined message sensitivity indicative value.

According to some embodiments, message sensitivity may be based on severity and likelihood of the evaluated message's potential impact.

According to some embodiments, the severity and likelihood may be determined by: determining the inspected message's target network address: correlating the target network address with a specific transportation network management unit and its transportation network related function; and factoring the type, location, operational function, or operational state of the specific transportation network management unit correlated with the inspected message's target network address.

According to some embodiments, message sensitivity may be based on severity and likelihood of the evaluated message's potential simulated/projected future impact.

According to some embodiments of the present invention, a system for context aware zero trust monitoring, may include monitoring agents functionally associated with and monitoring message communications to and from each of one or more transportation network management units regulating components of the rail transportation network.

Each of said agents may include: a transportation network message evaluation logic to detect adherence violations, of an agent intercepted message, from one or more protocols of the transportation network; and a communication module to relay indications of the evaluated message's detected violations to a system server.

A system server may include: a scoring module to calculate for the evaluated message a score, based on the types and number of relayed protocol violations; and a thresholding module to compare the calculated message score to a message adherence violation score threshold, wherein the threshold is calculated by applying an inverse relationship function on a message sensitivity indicative value factoring a severity level, or a likelihood level, of the evaluated message's potential impact on the transportation network.

According to some embodiments of the present invention, a method for context aware zero trust monitoring, may include: monitoring message communications to and from each of one or more transportation network management units regulating components of the rail transportation network, to intercept a communicated message; detecting adherence violations, of the intercepted message, from a set of protocols, each protocol associated with a different transportation network aspect; and relaying indications of the evaluated message's detected violations to a system server, each violation indication including: (a) the transportation network aspect associated with the detected violation and (b) a violation type indicator matching the detected violation, selected from within two or more violation types of that aspect.

According to some embodiments, the method may further include: calculating for the evaluated message, under each of the transportation network evaluated aspects, a score based on the types and number of detected protocol violations associated with that aspect; aggregating the evaluated message's scores under each of the evaluated aspects to generate an aggregated message score; and comparing the aggregated message score to a message adherence violation score threshold and validating the message if the aggregated message score is lesser than its adherence violation score threshold.

According to some embodiments, aggregating aspect scores may be based on the calculation of a central tendency measure of the scores.

According to some embodiments, aggregating aspect scores may include increasing the relative weight of a score associated with a specific transportation network aspect, in comparison to the weight of a score associated with another transportation network aspect.

According to some embodiments, the specific transportation network aspect score whose relative weight is increased may be the transportation network's safety aspect.

According to some embodiments, the threshold may be calculated by applying an inverse relationship function on a predetermined message sensitivity indicative value.

According to some embodiments, message sensitivity may be based on severity and likelihood of the evaluated message's potential impact.

According to some embodiments, the severity and likelihood may be determined by: determining the inspected message's target network address: correlating the target network address with a specific transportation network management unit and its transportation network related function; and factoring the type, location, operational function, or operational state of the specific transportation network management unit correlated with the inspected message's target network address.

According to some embodiments, message sensitivity may be based on severity and likelihood of the evaluated message's potential simulated or projected future impact.

According to some embodiments of the present invention, a method for context aware zero trust monitoring, may include: monitoring message communications to and from each of one or more transportation network management units regulating components of the rail transportation network, to intercept a communicated message; detecting adherence violations, of the intercepted message, from a set of protocols, each protocol associated with a different transportation network aspect; calculating for the evaluated message a score, based on the types and number of relayed protocol violations; and comparing the calculated message score to a message adherence violation score threshold, wherein the threshold is calculated by applying an inverse relationship function on a message sensitivity indicative value factoring a severity level, or a likelihood level, of the evaluated message's potential impact on the transportation network.

Functions, operations, components and/or features described herein with reference to one or more embodiments, may be combined or otherwise utilized with one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for context aware Zero Trust (ZT) monitoring of communication between transportation network management units, said system comprising:
monitoring agents to capture data packets carrying messages to and from transportation network management units of the transportation network, wherein at least one agent comprises:
a message extraction module to extract message content from captured packets and to identify the source and destination of the message packets from their respective packet metadata; and
a ZT risk assessment module to, based on content within a captured message and a classification of the destination unit of the captured message, identify potential risk the captured message may generate within the transportation network upon reaching its destination unit.

2. The system according to claim 1, wherein said ZT risk assessment module identifies risk by comparing actual timing of specific captured messages with timing parameters associated with transportation network operational rules relating to the source unit or destination unit of the message.

3. The system according to claim 2, wherein comparison of actual timing to timing parameters includes: (a) absolute location of message source or message destination; (b) relative distance of either message source or message destination to some network element, including between source and destination; and (c) relative timing between capture of related packets.

4. The system according to claim 2, wherein the timing parameters associated with transportation network operational rules are retrieved or extracted from time tabling of a periodical train schedule.

5. The system according to claim 1, wherein said ZT risk assessment module identifies risk by comparing a simulation of an operational result of a message of a captured packet arriving at its destination relative to the transportation network operational rules.

6. The system according to claim 2, wherein as part of identifying risk, said ZT risk assessment module calculates a Security Integrity Level (SIL) based on the comparison results' similarity level and the identified potential risk of the message packets increases or decreases inversely to the calculated SIL.

7. The system according to claim 6, wherein the ‘timing parameters associated with transportation network operational rules’ are associated with two or more different aspects of the transportation network, the SIL is separately assessed and scored for each of the aspects, and the scores of the different aspects are collectively aggregated to generate a combined captured message SIL level score.

8. The system according to claim 7, wherein aggregating aspect scores is based on the calculation of a central tendency measure of the scores.

9. The system according to claim 7, wherein aggregating aspect scores includes increasing the relative weight of a score associated with a specific transportation network aspect, in comparison to the weight of a score associated with another transportation network aspect.

10. The system according to claim 1, wherein as part of identifying risk, said ZT risk assessment module also factors a current state of one or more rolling stock functionally associated with the destination units.

11. The system according to claim 10, wherein said ZT risk assessment module also factors a predicted future state of one or more rolling stock functionally associated with the destination units.

12. The system according to claim 11, wherein the predicted future state is generated using a simulation of the transportation network, while factoring the rolling stock current state as the start of a simulation with simulation state evolution based on rolling stock compliance with the captured messages.

13. The system according to claim 10, wherein said ZT risk assessment module calculates a ZT risk level score based on the identified risk or risk level.

14. The system according to claim 10, wherein said ZT risk assessment module also factors a current state of one or more transportation network trackside units functionally associated with the destination units.

15. The system according to claim 14, wherein said ZT risk assessment module also factors a predicted future state of one or more trackside units functionally associated with the destination units.

16. The system according to claim 15, wherein the predicted future state is generated using a simulation of the transportation network, while factoring the trackside unit's current state as the start of a simulation with simulation state evolution based on trackside unit compliance with the captured messages.

17. The system according to claim 14, wherein the trackside unit is selected from the group consisting of: wayside, point machine, level cross, signal, train detection sensor and interlocking (IXL).

18. A method for context aware Zero Trust (ZT) monitoring of communication between transportation network management units, comprising:
monitoring communication between the transportation network management units to capture data packets carrying messages to and from the units;
extracting message content from captured packets and to identify the source and destination of the message packets from their respective packet metadata; and
identifying potential risk that a captured message may generate within the transportation network upon reaching its destination unit, based on content within the captured message and a classification of the destination unit of the captured message.

19. The method according to claim 18, wherein identifying potential risk that a captured message may generate includes comparing actual timing of specific captured messages with timing parameters associated with transportation network operational rules relating to the source unit or destination unit of the message.

20. The method according to claim 19, wherein identifying risk includes calculating a Security Integrity Level (SIL) based on the comparison results' similarity level and the identified potential risk of the message packets increases or decreases inversely to the calculated SIL.
